(19) United States
(12) Patent Application Publication
(10) Pub. No.: US 2011/0246527 A1
(43) Pub. Date: Oct. 6, 2011

(54) System, method and computer program product for associating a permission set with one or more users

(75) Inventors: Douglas C. Bitting, Pleasanton, CA (US); Steven Tamm, San Francisco, CA (US); Adam Torman, Oakland, CA (US); David Andrew Brooks, San Jose, CA (US)

(73) Assignee: salesforce.com, inc., San Francisco, CA (US)

(21) Appl. No.: 13/065,902

(22) Filed: Mar. 31, 2011

Related U.S. Application Data
(60) Provisional application No. 61/319,793, filed on Mar. 31, 2010.

(51) Int. Cl. G06F 17/30

(52) U.S. Cl. 707/784; 707/E17.001

(57) ABSTRACT

In accordance with embodiments, there are provided mechanisms and methods for associating a permission set with one or more users. These mechanisms and methods for associating a permission set with one or more users can enable improved access management, increased efficiency, enhanced security, reduced risk, greater governance, least privilege access, greater auditability, etc.

### CLAIM OF PRIORITY

This application claims the benefit of U.S. Provisional Patent Application 61/319,793, entitled “Permission Sets,” by Bitting et al., filed Mar. 31, 2010 (Attorney Docket No. SFC1P098+/188PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to access permissions, and more particularly to assigning one or more permissions to users.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventional systems may utilize permissions in order to manage the system access provided to one or more users of the system. For example, a profile containing one or more access permissions may be assigned to one or more users of a system in order to manage the access of the users. Unfortunately, the assignment of profiles has been associated with various limitations.

Just by way of example, one or more members of a group to which a profile is assigned may need access permissions different from those provided by the profile, where only one profile may be assigned to each member. However, current ways of providing different access permissions from those provided by the profile to the members may include creating a different profile and assigning the different profile to the members (which may effectively divide the group via non-synchronized profiles), modifying the profile shared by all members of the group (which may result in a security risk for non-targeted users), assigning an administrator profile to one or more group members (which may result in a security risk), etc. Accordingly, it is desirable to optimize the management of access permissions within a system.

### BRIEF SUMMARY

In accordance with embodiments, there are provided mechanisms and methods for associating a permission set with one or more users. These mechanisms and methods for associating a permission set with one or more users can enable improved access management, increased efficiency, enhanced security, reduced risk, greater governance, least privilege access, greater auditability, etc.

In an embodiment and by way of example, a method for associating a permission set with one or more users is provided. In one embodiment, a profile is associated with a plurality of users of a system, where the profile includes one or more permissions. Additionally, a permission set including one or more additional permissions is created. Further, the permission set is associated with one or more of the plurality of users.

While one or more implementations and techniques are described with reference to an embodiment in which associating a permission set with one or more users is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for associating a permission set with one or more users, in accordance with one embodiment;

FIG. 2 illustrates method for assigning a permission set necessitated by a promotion, in accordance with another embodiment;

FIG. 3 illustrates method for assigning a temporary permission set, in accordance with another embodiment;

FIG. 4 illustrates detail regarding a user's effective access, in accordance with another embodiment;

FIG. 5 illustrates exemplary administrative and user flows, in accordance with another embodiment;

FIG. 6 illustrates profiles with permission sets for administering shared rights, in accordance with another embodiment;

FIG. 7 illustrates a block diagram of an example of an environment wherein an on-demand database system might be used; and

FIG. 8 illustrates a block diagram of an embodiment of elements of FIG. 7 and various possible interconnections between these elements.

### DETAILED DESCRIPTION

### General Overview

Systems and methods are provided for associating a permission set with one or more users.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for associating a permission set with one or more users will be described with reference to example embodiments.

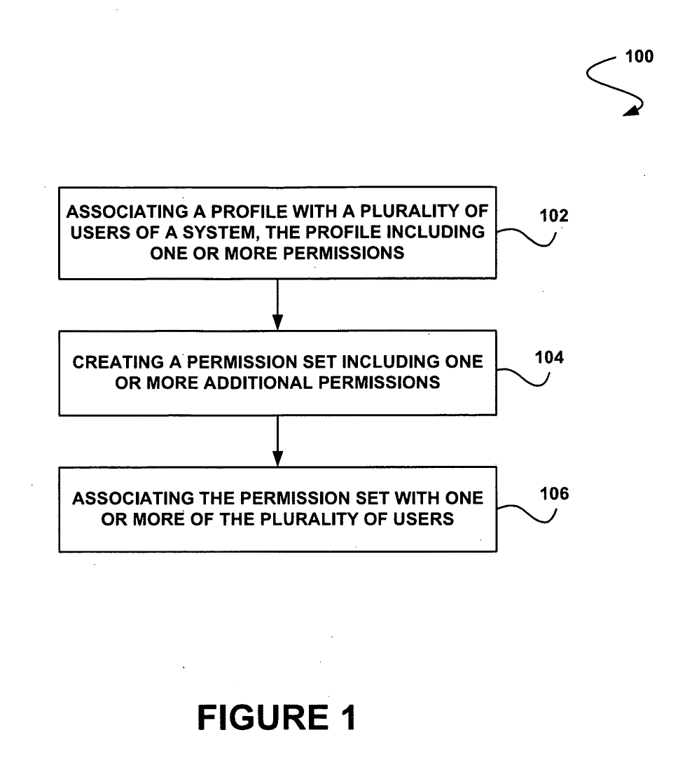

FIG. 1 illustrates a method 100 for associating a permission set with one or more users, in accordance with one embodiment. As shown in operation 102, a profile is associated with a plurality of users of a system, where the profile includes one or more permissions. In one embodiment, the users of the system may include any entity associated with the system. For example, the users of the system may include a client of the system, a customer of the system, etc. In another example, the users of the system may include an individual, a company, or any other entity.

Additionally, in one embodiment, the users of the system may be associated with one or more organizations of the system. For example, the users of the system may include a plurality of employees of an organization of the system. In another embodiment, the system may include a client, a server, a multi-tenant on-demand database system, etc. In another embodiment, each of the plurality of users may have one or more common aspects. For example, each of the plurality of users may have a similar role (e.g., functional role, etc.) within an organization of the system. For instance, each of the plurality of users may be an executive of an organization of the system, a manager of the organization of the system, a sales representative of the organization of the system, etc. In yet another embodiment, the profile may be associated with a particular role within an organization of the system. For example, the profile may be an executive profile, a manager profile, a sales profile, etc.

Further, in one embodiment, the profile may be associated with access to one or more elements of the system. For example, the permissions of the profile may include permissions to view particular system data, edit particular system data, delete particular system data, etc. In another embodiment, the permissions may be necessary to perform one or more actions within the system. For example, if one of the plurality of users attempts to perform an action within the system that requires permission, the one or more permissions associated with the user may be checked to see if the required permission is associated with the user and the user may be conditionally allowed to perform the action based on whether they have the required permission.

In yet another embodiment, associating the profile with the plurality of users of the system may include assigning the one or more permissions of the profile to the plurality of users. For example, the profile may include a collection of permissions that assigned to the plurality of users. In this way, each of the plurality of users of the system may have each of the permissions included within the profile, and may be able to perform the same actions within the system.

Further, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Further still, as shown in operation 104, a permission set including one or more additional permissions is created. In one embodiment, the additional permissions may include permissions other than the permissions included within the profile. In another embodiment, the additional permissions may be associated with one or more actions to be performed within the system. For example, the additional permissions may include permissions needed to perform the one or more actions within the system.

Also, in one embodiment, the additional permissions may increase the access to one or more elements of the system that was provided by the profile. In still another embodiment, the additional permissions may reduce the access to one or more elements of the system that was provided by the profile. Of course, however, the additional permissions may not affect the access provided by the profile.

In addition, in one embodiment, the permission set may be associated with a particular role within an organization of the system. For example, the permission set may be associated with a particular project of an organization of the system (e.g., an IT project to phase in a new application or set of functionality to a sampling of users across multiple functional roles, etc.), a promotion administered within the organization, a security risk within an organization of the system, etc. In another embodiment, the permission set may include a negative permission. For example, the permission set may remove or limit access to particular data within the system (e.g., restrict access to an API only which disallows a user from accessing the user interface, etc.).

Furthermore, as shown in operation 106, the permission set is associated with one or more of the plurality of users. In one embodiment, associating the permission set may include assigning the one or more additional permissions associated with the permission set to the one or more users. In another embodiment, the total permissions associated with the one or more users may include an aggregate of the one or more permissions included within the profile and the one or more additional permissions included within the permission set.

Further still, in one embodiment, the one or more users may be assigned the one or more permissions included within the profile in conjunction with the additional permissions included within the permission set. In this way, the one or more users may be able to utilize the access dictated by the aggregate of both the permissions of the profile and the additional permissions of the permission set while still maintaining a single profile (e.g., without having to switch their profile, etc.). Additionally, profiles may not need to be switched in order to perform actions utilizing permissions from the profile and the additional permissions from the permission set. Further, the user may not incur any additional thought or intention to take advantage of the access they've been granted. This may reduce the cost of an implementation and simplify a user's experience.

Also, in one embodiment, the permission set may be disassociated with the one or more users at a predetermined point in time. For example, the permission set may be associated with the one or more users when the one or more users are assigned to a project within the system, and may be disassociated (e.g., un-assigned, etc.) with the one or more users when the project is completed. In another embodiment, a plurality of different permission sets may be associated with one or more of the group of users, and the aggregate of the profile and all associated permission sets may dictate the effective access rights of the user. For example, each permission set may be provided for a different role, and a user that is assigned multiple roles may have each permission set for each role associated with them. In this way, additional privileges may be administered for users instead of additional profiles.

Additionally, in one embodiment, the permission set may be included within a license (e.g., a package license, a feature license, etc.). For example, the permission set may be automatically associated with the one or more users if the one or more users purchase an application having a license in which the permission set is included. In another embodiment, the consistency of the permission set may be validated before the permission set is associated with the one or more users. For example, it may be validated that the permission set does not conflict with the profile or other permission sets assigned to a user before the permission set is associated with the user. In another example, consistency may include ensuring that all permission dependencies and other required permissions are enabled. For instance, if a customize application permission is enabled, a view setup and configuration permission may be automatically enabled to ensure the user can both view and customize the setup. In another embodiment, the permission set may be included within a package.

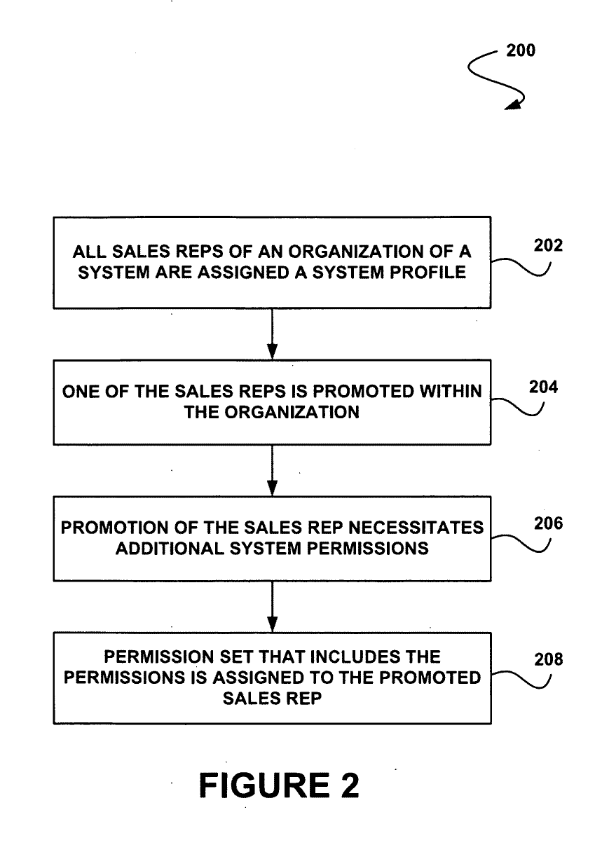

FIG. 2 illustrates a method 200 for assigning a permission set necessitated by a promotion, in accordance with another embodiment. As an option, the method 200 may be carried out in the context of the functionality of FIG. 1. Of course, however, the method 200 may be carried out in any desired environment. The aforementioned definitions may apply during the present description.

As shown in operation 202, all sales representatives of an organization of a system are assigned a system profile. In one embodiment, the system profile assigned to the sales representatives may include all permissions needed by the sales representatives to perform their duties within the organization. For example, the system profile may provide the sales representatives with permission to access a plurality of opportunities, fields of opportunities, etc. In another embodiment, the permissions provided to the sales representative through the system profile may be adjusted by altering the system profile.

Additionally, as shown in operation 204, one of the sales representatives is promoted within the organization. Additionally, as shown in operation 206, it is determined that the promotion of the sales representative necessitates additional system permissions beyond those available within the system profile assigned to the sales representative. For example, the promoted sales representative may need the ability to transfer records within the system, delete records within the system, etc.

Further, as shown in operation 208, a permission set that includes the permissions necessitated by the promotion of the sales representative is assigned to the promoted sales representative. For example, if it is determined that the promotion necessitates permission to transfer records within the system and delete records within the system, then such permissions may be included within the permission set. In one embodiment, the permission set may be assigned to the sales representative by a system administrator.

In this way, the system administrator of the sales representatives may more easily manage sales representative rights. Additionally, the promoted sales representative still has the same system profile as all other sales representatives, such that if the permissions associated with the system profile changes, the permissions of the promoted sales representative may change in synchronization with the permissions of the other sales representatives. Further, the permissions associated with the promoted sales representative may be adjusted without having to create a new profile for the sales representative and without having to adjust the system profile of all the sales representatives within the system.

In another embodiment, it may be later determined that the permission set assigned to the promoted sales representative contains permissions that are too broad for the promoted sales representative (e.g., root access, etc.), or that the promotion is taken away from the sales representative. In response to this, the assigned permission set may be removed from the sales representative without affecting the system profile of any of the sales representatives.

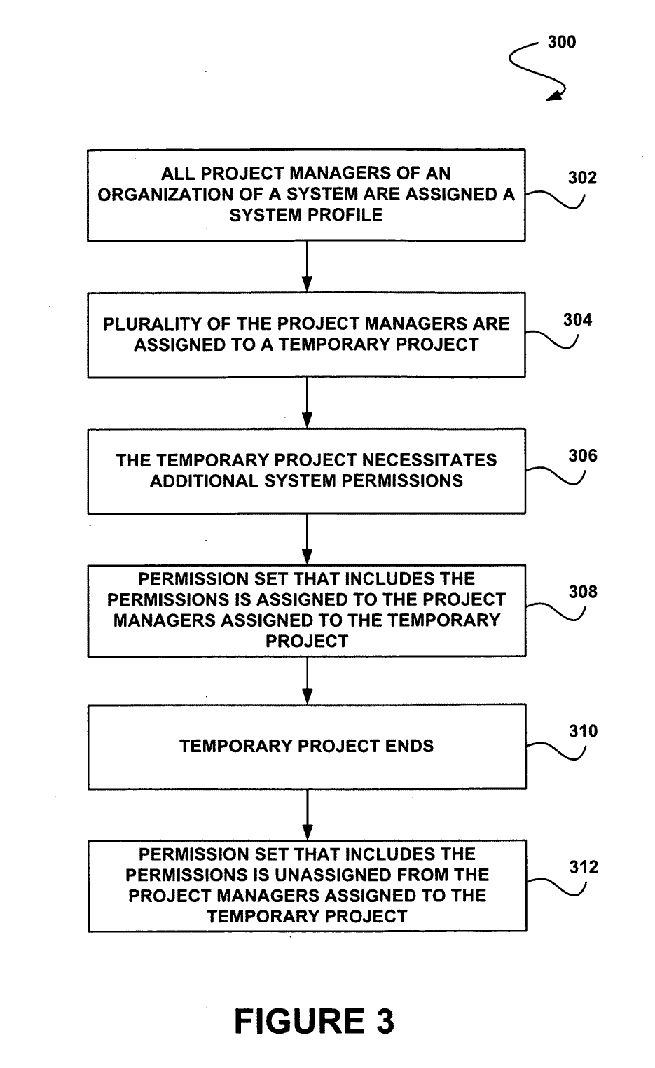

FIG. 3 illustrates a method 300 for assigning a temporary permission set, in accordance with another embodiment. As an option, the method 300 may be carried out in the context of the functionality of FIGS. 1-2. Of course, however, the method 300 may be carried out in any desired environment. The aforementioned definitions may apply during the present description.

As shown in operation 302, all project managers of an organization of a system are assigned a system profile. Additionally, as shown in operation 304, a plurality of the project managers is assigned to a temporary project within the organization in addition to their duties as project managers. Further, as shown in operation 306, it is determined that the temporary project necessitates additional permissions beyond those available within the system profile assigned to the project managers. For example, the project managers assigned to the temporary project may need broader access rights (e.g., the ability to delete items from within the organization, etc.) in order to assist with the temporary project.

Further still, as shown in operation 308, a permission set including permissions necessitated by the temporary project are assigned to the plurality of managers assigned to the temporary project. Also, as shown in operation 310, it is determined that the temporary project has ended. Additionally, as shown in operation 312, the permission set including permissions necessitated by the temporary project is unassigned from the plurality of managers assigned to the temporary project. In this way, permission sets of the managers may be dynamically changed according to project-based permissions that may be granted or removed as projects are started and finished.

In one embodiment, a permission set may be an abstraction around the various constructs found on a user's profile that encapsulate a user's set of permissions. Unlike profiles, which have a many-to-one relationship with users, permission sets may be designed to have a many-to-many relationship with users. Effectively, permission sets may allow a layering of permissions that are assigned to users. There are many use cases for which this type of functionality may be useful, including, but not limited to: avoiding one-off profiles; structuring permissions across functional, rather than organization lines; migrating feature licenses into permission sets to streamline license provisioning, grouping permissions by region due to regional security regulations, grouping permissions by application, phasing in IT projects by releasing functionality to subsets of users, and enforcing governance policy by migrating permissions from multiple profiles into a single permission set (which may make auditability easy by looking up the users assigned the one permission set), etc.

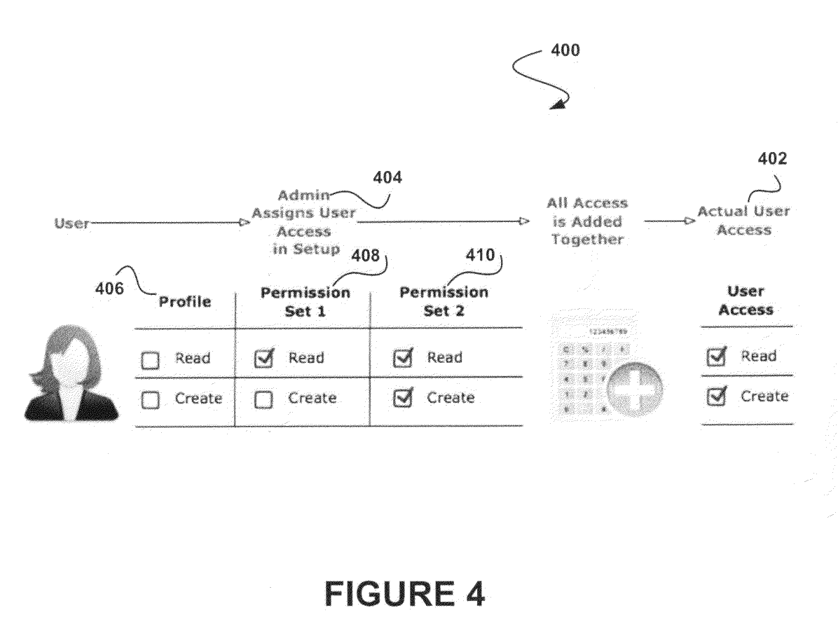

From a multi-tenant point of view, layering permissions to enable efficient administration may be provided. For example, multiple collections (e.g., a version of profiles) may be layered to a user. As a result, a user may have to ‘change’ their collection to transition to a new set of rights. With permission sets, there may be no need for a user to change their collection of permissions in order to perform a task; all rights may be layered together to provide a new ‘effective access’ for the user, simplifying their interaction and ensuring that they may perform tasks from various collections without having to manage the transition. In the multi-tenant nature of this technology, a user's effective access may be provided in software as a service model. The more detail regarding a user's effective access is shown in FIG. 4, where the user's actual access 402 is determined by aggregating the user's assigned access 404, which includes both the user's permission profile 406 and permission sets 408 and 410.

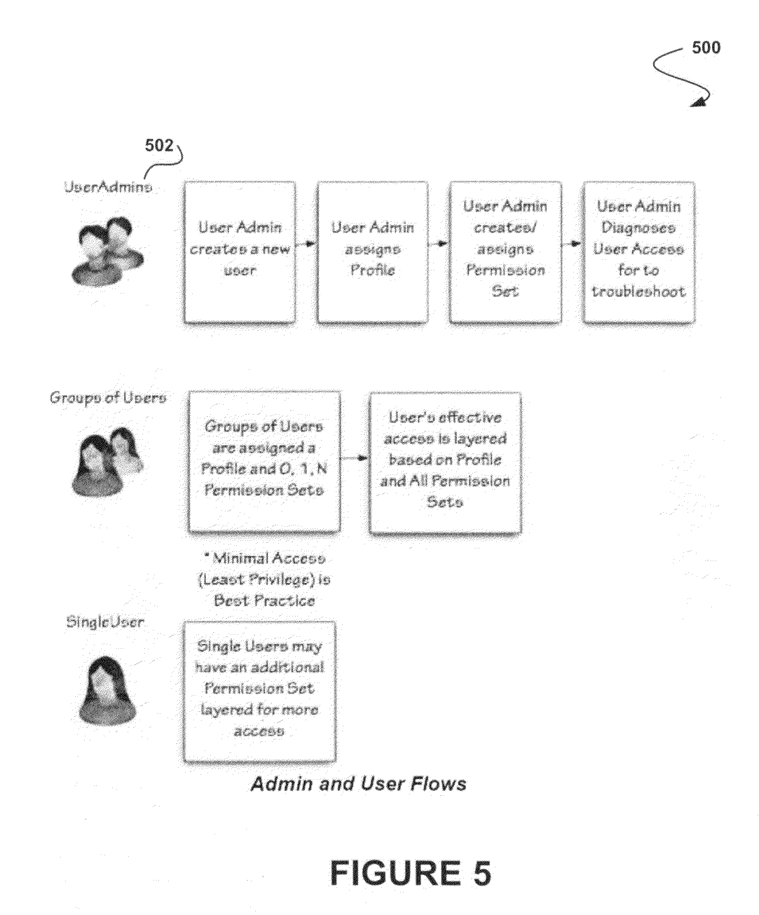

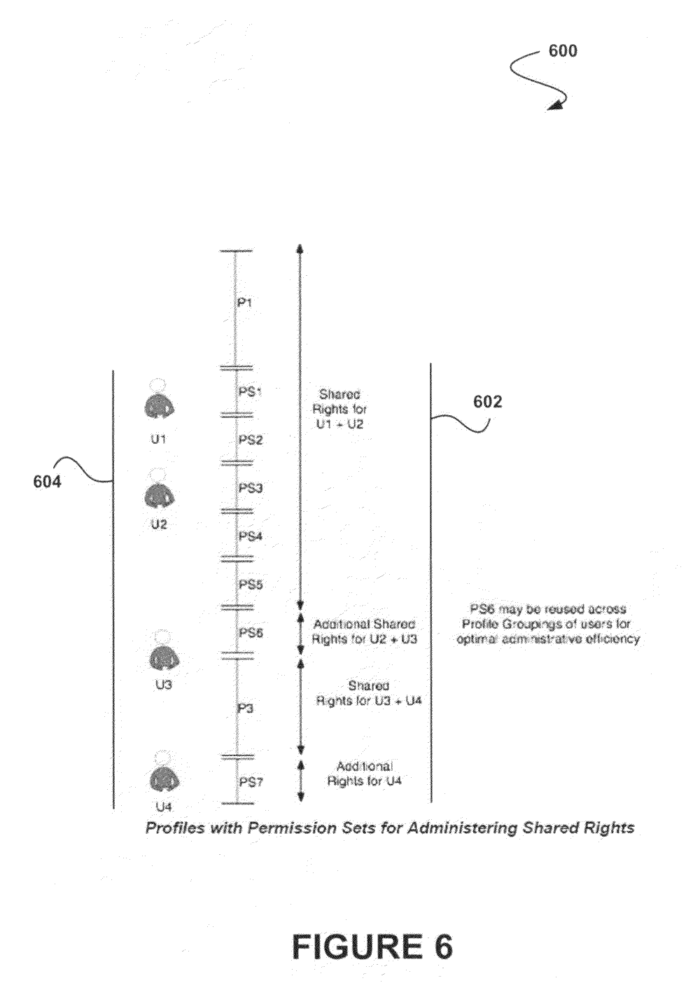

Further still, FIG. 5 illustrates exemplary administrative and user flows 500, including processes used by an administrator 502 to administer permissions. Also, FIG. 6 illustrates profiles with permission sets for administering shared rights 600, where various rights 602 are shared by a plurality of users 604, and where the users 604 may not have to share profiles in order to share permission sets.

Further still, in another embodiment, the constructs that may optionally be targeted for permission sets include user permissions, object level permissions, FLS, apex class security, visual force page security, desktop integration clients, custom settings, login hours, IP ranges, etc. In another embodiment, manageability tools, permission sets into the licensing and provisioning, stories for partners, etc. may be incorporated. In yet another embodiment, an organization permission and an organization preference may be introduced. Profiles may begin migrating to making use of the permission set infrastructure. It should be noted that where this document refers generically to “permissions,” in one embodiment, this may include the set of permission-related information managed by permission sets.

Also, in one embodiment, permission sets may include a concept the grows out of a desire to support several different use cases that require breaking away from the “One Profile Shall Rule Them All” architecture. In general, permission sets may be designed to be additive sources of permission information. For example, a user's effective permissions may be the union of all permission sets associated with that user. If a permission is granted to the user via one or more permission sets, then the user's effective permissions may include that capability.

In another embodiment, additive permissions may be a concept that works well for binary constructs, but support for other constructs may require a bit more definition. Login hours and IP Ranges may be easily additive since they both specify ranges that can be effectively combined. Numeric limits may be optionally included.

Additionally, in one embodiment, the introduction of permission sets may alter how various permission related bits of information are accessed. In another embodiment, all permission related functionality may be moved out to permission sets. User permissions and entity permissions may be focused on. These may be good examples of the types of changes that may be required in order to support other constructs. Further, entity permissions may be already stored in their own database table and related entity object. This structure may not require any additional changes beyond allowing entity permissions to be parented by permission sets. User permissions today may be stored directly on the profile object. Further still, a permission set object may include a home for this information.

Further, in one embodiment, a new entity (e.g., a permission set, etc.) may be introduced and used to store parent related permission information. This object may have a relationship to either a user or profile. A profile may be able to have a single permission set; a user will be able to have multiple permission sets. Because the ability to surface permission sets and assign them to users may be provided, these capabilities may be hidden behind an org permission and an org preference. To enable the many-to-many relationship between users and permission sets, a PermissionSetAssignment object may be also defined. The name of the assignee may be left generic (i.e., assignee_id vs user_id) as future roadmaps calls for permission sets to be assignable to an application role construct.

Further still, in another embodiment, each permission set may be associated with a particular user license and may only be assigned to profiles which share the same user license type. When assigning permission sets to users, it may be ensured that the user is assigned to a profile of the expected user license type. This may be altered to allow permission sets to consume licenses directly. In yet another embodiment, a level of abstraction may be introduced between profiles and user permissions. Additionally, a new vector may be created for adding permissions to users. However, the data set sizes in both cases may be reasonably constrained. In one example, customer's cardinality for users may be tens of thousands and (custom) profiles may be in the low 200s. Use cases that require arbitrary joins between these data sets may be quite limited; in most cases, a given user or a given profile may be started with, which may constrain the possible scalability and performance implications.

In still another embodiment, an existing profile and calculated permissions (i.e., that which is cached in UserInfo, etc.) architecture may leverage Distributed Cache in order to improve performance and reduce load on the database. This capability may be leveraged by storing the profile's calculated permissions within the ProfileInfo/UserInfo. Support may be added for caching permsets directly.

Also, in one embodiment, a layer of abstraction may be added between the profile and the user's permissions. This may require changes throughout Java and PLSQL where users' permissions are calculated and used. These changes are generally straight forward, and may include the following: Where the “permissions” field of the Profile entity is referenced, one of two things should be done: Reference the calculated permissions for the user (this may be the more normal use case since most references to profile permissions are for the purposes of determining the context user's permissions), or Reference the “permissions” field of the associated PermissionSet (this may be less common, for those cases where this information is used for display purposes (e.g., during profile edit), etc.).

This same strategy may apply for dealing with Entity Permissions. One bit this is worth pointing out is that the calculation of the user's current set of permissions may be altered to include not just the permissions associated with the profile's related permset, but may also include information from those permsets directly associated with the user. This calculation may occur in much the same way that a user's context is populated with permission information.

In another embodiment, all the data that is currently associated with profiles may be moved to their related permission set analogue. A cleanup script may be run during the down window to capture those profiles that changed after the initial iteration. It may be ensured that this is one of the later scripts run in the down window to ensure that any scripts run during the down window against core.profile don't come along behind this and update the permission information for a given profile.

Additionally, in one embodiment, permission sets may be used to create a minimal profile for the largest group of users possible. Because permission sets may only encompass permissions/access, this may be defined by how an organization segments the forms (page layouts), tabs, and apps (tabsets) that a group of users may use. For instance, if an organization has defined two sets of page layouts for opportunities to enable the inside and field sales groups, two profiles may be needed to differentiate the user's experience with the application.

In another embodiment, permission sets may be created based on the lowest common denominator (e.g., least privilege, etc.) for a collection of permissions necessary for any single group of users. For instance, if the lowest common denominator for a functional group of advanced reporting permissions is to include the run reports, create and customize reports, manage public reports, and manage dashboard permissions, a single permission set may be created containing all of these permissions and may be assigned to all users in the organization regardless of what other business segmentations they may participate in such as sales operations or support operations.

However, if a larger group of users should have access only to manage dashboards, a permission set with that single permission may be created and added to all users who need just that one permission. Creating this simple permission set may allow the administrator to evaluate whether to create a single permission set for this permission or to add it to either of the previously mentioned permission sets when future permissions are introduced such as manage dynamic dashboards, which may automatically increase all users effective access who are assigned to the permission sets. Because all permissions may layer, the administrator may now have more flexibility in creating logical functional groups of permissions to assign to users.

Further, in one embodiment, one or more permission sets may be incorporated into a license (e.g., package licenses, feature licenses, etc.). The license may include a manageable entity that may control the allowed capabilities associated with metadata objects controlled by a package. This may include object level data permissions (e.g., CRUD 2.0, etc.), object level metadata permissions (e.g., setup, etc.), field level data permissions, record type availability, tab visibility, apex class/page security, package-specific capabilities (i.e. package, etc.), etc. Also, see, for example, U.S. patent application Ser. No. 11/866,898, Attorney Docket Number 021735-003410US (037US), filed Oct. 3, 2007, which is hereby incorporated by reference in its entirety, and which describes exemplary techniques for utilizing package licensing and package roles.

Further still, in one embodiment, the developer may be allowed to restrict the license even further, utilizing allowed user types (e.g., portal, guest, platform, etc.), allowed interaction types (e.g., UI only, API, Clients, Reporting, etc.), billing (e.g. unlimited, usage-based, etc.), etc. This may be similar to an existing user license, except, instead of just limiting CRUD on standard objects, it may limit everything on custom objects.

A package may include a collection of metadata associated with a publisher. It may be self contained, in that it cannot make reference to entities defined outside the package, although it can “extend” an existing package. Notionally, each package may be associated with a namespace prefix defined by the publisher. Table 1 illustrates exemplary types of packages within an organization. Of course, it should be noted that the package types shown in Table 1 are set forth for illustrative purposes only, and thus should not be construed as limiting in any manner.

```
TABLE 1
Standard Platform: Provides access to “standard” functionality that applies across
applications. This may include home, activities, documents, reporting,
search, tagging, etc.
Standard App: Existing “standard” objects/fields.
    Personal Edition Equivalent: may provide access to accounts and contacts. This
    may allow parity with the existing personal edition, while separating it from the
    standard platform package which. The use case for this may include creating a
    ‘tabular rasa’ blank slate application from scratch without having accounts and
    contacts. E.g. A clinical trials application where the main object is a type of
    product and all business logic is custom using Apex and workflow.
    CRM: Provides access to the CRM application. This may include leads,
    campaigns, products, opportunities, etc. This package may also include
    CTI (call center edition) and console (business web desktop) in order to
    accommodate the cross CRM functionality inherit in these features.
    Ideas: Provides access to the Ideas application. This may include ideas and
    communities. This may be a “stand-alone” package and may not be dependent on
    anything else.
    Content: Provides access to the content application. This may include
    workspaces, contributions, subscriptions, and content. This may be a “stand-
    alone” package and may not be dependent on anything else.
ISV Packages: may include current “app exchange” apps, defined in a DE org and
installed into a subscriber org. Every metadata object may have a namespace_prefix (e.g.
Stamm1234_CustomObjectName, etc.)
Customer Packages: Every “custom” entity defined in a subscriber org, including
custom fields/record type on CRM/Platform objects. every metadata object may have a
“NULL” namespace_prefix. This may be known as the Happy Soup.
```

Further, in one embodiment, a permissions set may include a collection of permissions that can be assigned to a user, such as package licenses, package roles, permissions allowed by the package license, but not necessarily included in the package role, etc. In the same way that “standard” profiles may be used, “standard” package roles may be used in a permissions set. The “owner” of a permission set may include a user, profile, group, user role, etc. In another embodiment, package roles and permissions may be assigned directly to a user, and that user may be optionally assigned to a group, and then the permission may then be assigned to that group.

In yet another embodiment, the “group” may include a special “PermSet group” with different administrative rights that may be required to create it. The reason for it needing to be “special” may be because group membership may require license checks. As a result, this may be different from public and private groups used for sharing. Additionally, standard and packaged components may need to remain “immutable” by the customer. In fact, these rows may not be stored in the database, they might just be defaults defined in the ether. Further, customizations or extensions may not be defined in the package, but instead overridden in the permission set space. By breaking permissions out into top level objects, you can assign them as desired. In another embodiment, an entity such as an ISP may control access controls using installable permission sets. In yet another embodiment, the levels of access, permissions, etc. granted using the package license may be monetized.

Table 2 illustrates an exemplary permission set group for a product manager. Of course, it should be noted that the group shown in Table 2 is set forth for illustrative purposes only, and thus should not be construed as limiting in any manner.

TABLE 2

```
Package Licenses:
    Platform User
    CRM Standard User
    TOM User
    Scrumforce User
    L&P User
Standard Package Roles
    Platform Standard User
    CRM Standard User
    TOM User
    Scrumforce Product Owner
Cloned Package Roles
    L&P Read Only
Permission Overrides
    Admin Permission Level: PILOT
    View All Data: Opportunities
    FLS Hidden: Opportunity Amount
```

In this way, pre-created or standard permission sets may be inserted into an organization, and permission sets may be allowed to be cloned and customized within an organization.

Table 3 illustrates an implementation of the auditing of changes to permission sets. Of course, it should be noted that the implementation shown in Table 3 is set forth for illustrative purposes only, and thus should not be construed as limiting in any manner.

TABLE 3

| | | | What should it | | |
|---|---|---|---|---|---|
| | | | be (Action | | |
| Rank | Where | What | String) | Substitutions | Example |
| 1 | Via the | New (Save) | Created | {0} = New | Created permission set |
| | PermissionSet | Permission | permission set | Permission Set | Modify All Data using |
| | page | Set | {0} using user | Label | user license Full CRM |
| | | | license {1} | {1} = User | |
| | | | | License Label | |
| 2 | Via the | Clone | Created | {0} = New | Created permission set |
| | PermissionSet | (SaveAs) | permission set | Permission Set | Modify All Data using |
| | page | Permission | {0} using | Label | permission set Uber |
| | | Set | permission set | {1} = Old | Admin with user license |
| | | | {1} with user | Permission Set | Full CRM |
| | | | license {2} | Label | |
| | | | | {2} = User | |
| | | | | License Label | |
| 3 | Via the | Change | Changed | {0} = | Changed permission set |
| | PermissionSet | Permission | permission set | Permission Set | Data Admin: Permission |
| | page | Set Name | {0}: permission | Label | Set developer name was |
| | | | set developer | {1} = Old | changed from |
| | | | name was | Permission Set | Data_Admin to |
| | | | changed from | Name | Modify_All_Data |
| | | | {1} to {2} | {2) = New | |
| | | | | Permission Set | |
| | | | | Name | |
| 4 | Via the | Change | Changed | {0} = New | Changed permission set |
| | PermissionSet | Permission | permission set | Permission Set | Data Admin: Permission |
| | page | Set Label | {0}: permission | Label | Set label was Modify All |
| | | | set label was | {1} = Old | Data |
| | | | {1} | Permission Set | |
| | | | | Label | |
| 5 | Via the | Permission | Changed | {0} = | Changed permission set |
| | PermissionSet | Set | permission set | Permission Set | Data Admin: |
| | page | Description | {0}: description | Label | Description was changed |
| | | | was changed | | |
| 6 | Via the | User | Changed | {0} = | Changed permission set |
| | PermissionSet | Permissions | permission set | Permission Set | Data Admin: Modify All |
| | page | | {0}: | Label | Data permission was |
| | | | {1} permission | {1} = User | changed from disabled |
| | | | was changed | Permission | to enabled |
| | | | from {2} to {3} | Label | |
| | | | | {2} = State - | |
| | | | | enabled or | |
| | | | | disabled | |
| | | | | {3} = State - | |
| | | | | enabled or | |
| | | | | disabled | |
| 7 | Via the User | User Assign | Assigned | {0} = | Assigned permission set |
| | Related List | | permission set | Permission Set | Data Admin to user |
| | | | {0} to user {1} | Label | David Hacker |
| | | | | {1} - User | |
| | | | | Name | |
| 8 | Via the User | User | Unassigned | {0} = | Unassigned permission |
| | Related List | Unassign | permission set | Permission Set | set Data Admin from |
| | | | {0} from user {1} | Label | user David Hacker |
| | | | | {1} = User | |
| | | | | Name | |
| 9 | Via Permission | Permission | Deleted | {0} = | Deleted permission set |
| | Set Page or List | Set Delete | permission set | Permission Set | Data Admin |
| | View | | {0} | Label | |

Additionally, in one embodiment, unlike profiles which hide the developer name (which only displays in the metadata api—e.g. System Administrator becomes Admin.profile, etc) and only display the name as a label, permission sets may display both. The permission set label field may be used to identify the permission set but only needs to respect security settings (e.g. no XSS, CSRF, etc.). The permission set name field must be unique, begin with a letter, not include spaces, not end with an underscore, not contain two consecutive underscores, etc.

If a user changes the permission set label, there may not be a warning unless they are also changing the name field at the same time, in which case they should receive an error message, stating: “The name you specified already exists for your organization. You must specify a unique name.” In addition to a name and label field, there may be a description, long text area field, a last modified by field, and a created by field. Profiles and permission sets may be named the same, but a unique name constraint may be used where a name cannot be shared between both a profile and a permission set. This may help with the total access query story to prevent both a profile and a permission set being returned with the same name and not understanding the distinction between the two.

Additionally, in one embodiment, one or more save validations may be run that determine that a user should have one or more permissions, and also determine that if the removal of one or more permission sets may also remove those mandatory permissions, the removal may be stopped. In another embodiment, a user's security settings may always have the greatest integrity to ensure that rights necessary to perform some function are guaranteed. Because profiles and permission sets may represent groups of users, but only a subset of specific users may require permissions found within the profile or permission set, maintaining the integrity of the whole grouping may be essential for the few who need it. If by taking away a permission, a subset of users who require it would lose some fundamental access, then validating any changes when saving a profile, a permission set, or a profile/permission set assignment to a user may be essential for end-users to do their jobs properly. In this way, the permission set may be validated as inherently consistent. In another embodiment, the one or more save validations may be applied across one or more organizations within the system, thereby reducing administrative error and reducing overhead.

Further, in one embodiment, permission sets may be reassigned. In one embodiment, one or more permissions sets may not be reassigned, one or more permission sets may be on a select list of profiles that may be reassigned, etc. In another embodiment, if a user attempts to delete a permission set, either from a list view or from the detail page, that is not assigned to a user, they may be warned with a pop-up message (e.g., “Are you sure you want to delete this permission set”). If a user tries to delete a permission set that is assigned to a user, they may be prevented and the following message should be shown to the user: “You cannot delete a permission set that is in use. The permission you attempted to delete is assigned to one or more users. Only permission sets that aren't assigned to users may be deleted. Click here to return to the previous page.”

### System Overview

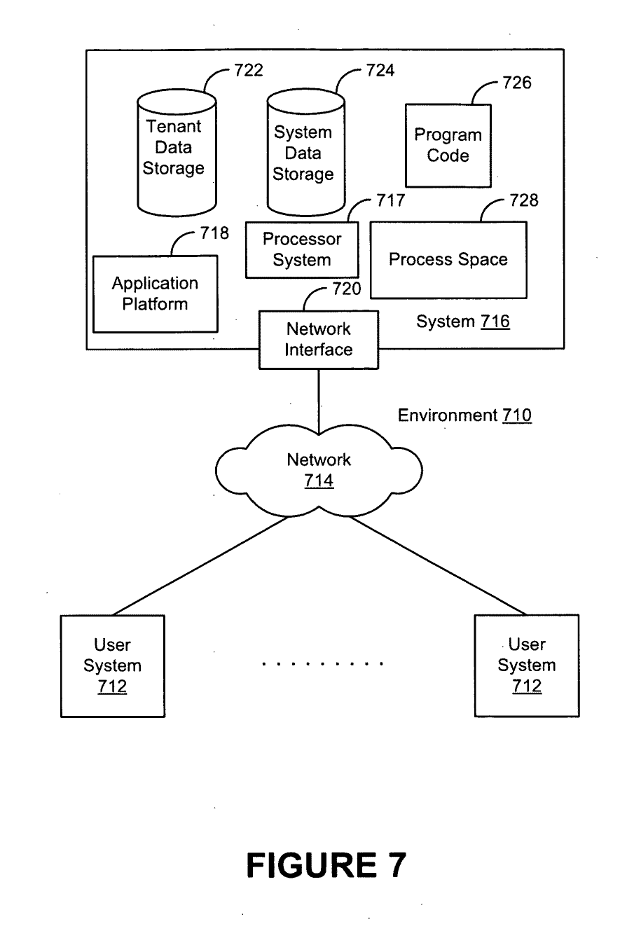

FIG. 7 illustrates a block diagram of an environment 710 wherein an on-demand database system might be used. Environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

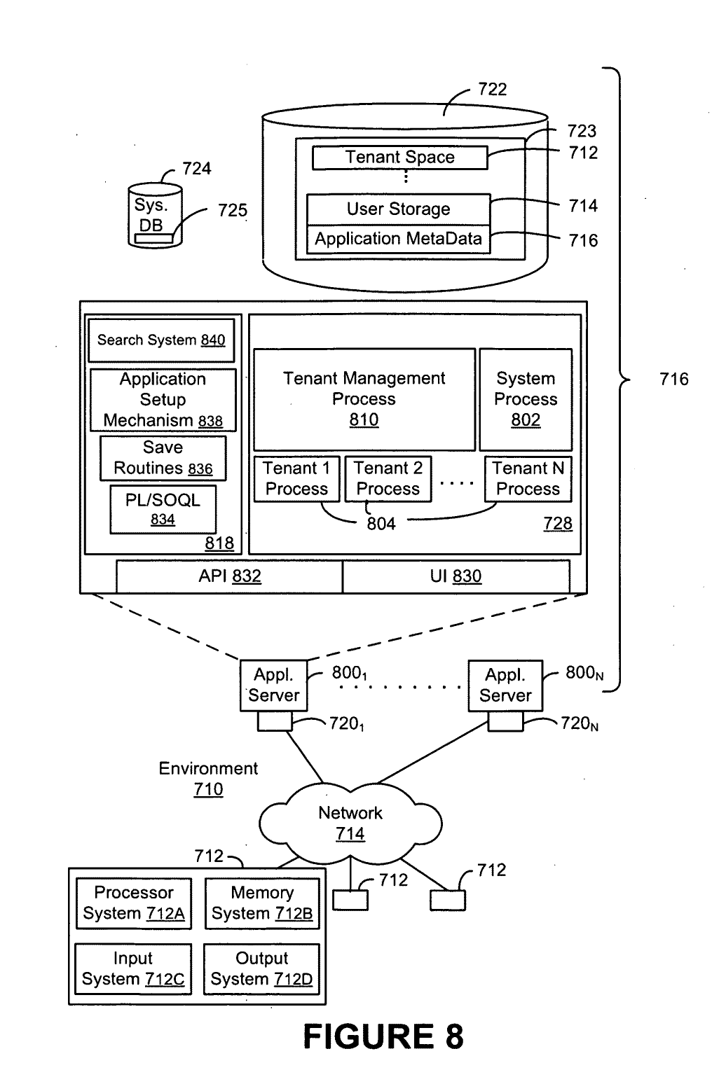

Environment 710 is an environment in which an on-demand database system exists. User system 712 may be any machine or system that is used by a user to access a database user system. For example, any of user systems 712 can be a handheld computing device, a mobile phone, a laptop computer, a work station, and/or a network of computing devices. As illustrated in FIG. 7 (and in more detail in FIG. 8) user systems 712 might interact via a network 714 with an on-demand database system, which is system 716.

An on-demand database system, such as system 716, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 716” and “system 716” will be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database system 716 may include an application platform 718 that enables creation, managing and executing one or more applications developed by the provider of the on-demand database system, users accessing the on-demand database system via user systems 712, or third party application developers accessing the on-demand database system via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 also illustrates environment 710. However, in FIG. 8 elements of system 716 and various interconnections in an embodiment are further illustrated. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 8001-800N, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 8001 might be coupled via the network 714 (e.g., the Internet), another application server 800N-1 might be coupled via a direct network link, and another application server 800N might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 Big-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method for associating a permission set with one or more users, the method comprising:
associating a profile with a plurality of users of a system, the profile including one or more permissions;
creating a permission set including one or more additional permissions; and
associating the permission set with one or more of the plurality of users.

2. The computer program product of claim 1, wherein the users of the system include a plurality of employees of an organization of the system.

3. The computer program product of claim 1, wherein each of the plurality of users has a similar role within an organization of the system.

4. The computer program product of claim 1, wherein the profile is associated with a particular role within an organization of the system.

5. The computer program product of claim 1, wherein the computer program product is operable such that if one of the plurality of users attempts to perform an action within the system that requires permission, the one or more permissions associated with the user may be checked to see if the required permission is associated with the user, and the user is conditionally allowed to perform the action based on whether they have the required permission.

6. The computer program product of claim 1, wherein associating the profile with the plurality of users of the system includes assigning the one or more permissions of the profile to the plurality of users.

7. The computer program product of claim 1, wherein the additional permissions include permissions other than the permissions included within the profile.

8. The computer program product of claim 1, wherein the additional permissions include permissions needed to perform the one or more actions within the system.

9. The computer program product of claim 1, wherein the additional permissions increase access to one or more elements of the system that was provided by the profile.

10. The computer program product of claim 1, wherein the additional permissions reduce the access to one or more elements of the system that was provided by the profile.

11. The computer program product of claim 1, wherein the permission set is associated with a particular project of an organization of the system.

12. The computer program product of claim 1, wherein associating the permission set includes assigning the one or more additional permissions associated with the permission set to the one or more users.

13. The computer program product of claim 1, wherein the total permissions associated with the one or more users include an aggregate of the one or more permissions included within the profile and the one or more additional permissions included within the permission set.

14. The computer program product of claim 1, wherein the permission set is disassociated with the one or more users at a predetermined point in time.

15. The computer program product of claim 1, wherein the computer program product is operable such that a plurality of different permission sets are associated with one or more of the group of users, and the aggregate of the profile and all associated permission sets dictate effective access rights of the user.

16. The computer program product of claim 1, wherein the computer program product is operable such that the permission set is included within a license.

17. The computer program product of claim 1, wherein a consistency of the permission set is validated before the permission set is associated with the one or more users.

18. The computer program product of claim 17, wherein it is validated that the permission set does not conflict with the profile or other permission sets assigned to a user before the permission set is associated with the user.

19. A method, comprising:
associating a profile with a plurality of users of a system, the profile including one or more permissions;
creating a permission set including one or more additional permissions, utilizing a processor; and
associating the permission set with one or more of the plurality of users.

20. An apparatus, comprising:
a processor for:
associating a profile with a plurality of users of a system, the profile including one or more permissions;
creating a permission set including one or more additional permissions; and
associating the permission set with one or more of the plurality of users.

21. A method for transmitting code for use in a multi-tenant database system on a transmission medium, the method comprising:
transmitting code for associating a profile with a plurality of users of a system, the profile including one or more permissions;
transmitting code for creating a permission set including one or more additional permissions, utilizing a processor; and
transmitting code for associating the permission set with one or more of the plurality of users.
